(19) United States
(12) Patent Application Publication
(10) Pub. No.: US 2013/0297240 A1
(43) Pub. Date: Nov. 7, 2013

(54) METHODS AND SYSTEMS FOR IMPROVED TIME COST AND ACCURACY OF ENERGY USAGE BASELINING

(71) Applicants: Drew Jon Dutton, Austin, TX (US); Robert Bartmess, Austin, TX (US)

(72) Inventors: Drew Jon Dutton, Austin, TX (US); Robert Bartmess, Austin, TX (US)

(73) Assignee: SIEMENS INDUSTRY, INC., Alpharetta, GA (US)

(21) Appl. No.: 13/463,901

(22) Filed: May 4, 2012

(51) Int. Cl. G06F 19/00

(52) U.S. Cl. 702/61

(57) ABSTRACT

Systems, methods, and mediums generate an energy usage baseline. A method includes receiving historical energy usage data for a building. The method includes identifying a historical energy usage baseline as a function of temperature based on the historical energy usage data. The method includes receiving measurements for current energy usage for the building to form a set of energy usage measurements. The method includes associating the set of energy usage measurements with values for temperature for an area where the building is located. The method includes generating a correction factor for the historical energy usage baseline based on a comparison of the set of energy usage measurements with a portion of the historical energy usage baseline corresponding to the values for temperature associated with the set of energy usage measurements. The method includes generating an adjusted energy usage baseline by applying the correction factor to the historical energy usage baseline.

### TECHNICAL FIELD

The present disclosure is directed, in general, to energy usage and, more particularly, to improving time cost and accuracy in identifying a baseline of energy usage.

### BACKGROUND OF THE DISCLOSURE

In order to measure energy savings provided by implementing management systems and products, it is helpful to have an energy usage baseline to measure current energy usage against. Previously used solutions included metering energy consumption over a long period of time, for example, an entire year, before installing any energy saving products. The requirement for this long period of time for metering is based on the need to acquire sufficient data for temperature and seasonal energy usage variations. One solution for establishing this energy usage baseline would include not implementing the energy saving management systems and products at the energy consumer's location until a year of data could be gathered. This solution would allow all of the temperature changes and operational behavior of the location to be included in the energy usage baseline.

However, modeling energy usage before installing energy saving products can be unreasonable from a business perspective. Consumers do not want to have to wait for a long period of time before realizing energy savings. Business considerations call for reducing the timeframe for establishing this energy usage baseline in order for the consumer to enjoy the benefits of energy saving products. Additionally, it may be difficult for all non-temperature variables, such as, traffic level, operational conditions, and appliance efficiency, to remain constant for a year. If some of these variables change, some or all of the data obtained from monitoring the energy usage can become invalid.

### SUMMARY OF THE DISCLOSURE

Various disclosed embodiments relate to systems and methods for generating an adjusted energy usage baseline.

Various embodiments include automation systems, methods, and mediums. A method includes receiving historical energy usage data for a building. The method includes identifying a historical energy usage baseline as a function of temperature based on the historical energy usage data. The method includes receiving measurements for current energy usage for the building to form a set of energy usage measurements. The method includes associating the set of energy usage measurements with values for temperature for an area where the building is located. The method includes generating a correction factor for the historical energy usage baseline based on a comparison of the set of energy usage measurements with a portion of the historical energy usage baseline corresponding to the values for temperature associated with the set of energy usage measurements. Additionally, the method includes generating an adjusted energy usage baseline by applying the correction factor to the historical energy usage baseline.

The foregoing has outlined rather broadly the features and technical advantages of the present disclosure so that those skilled in the art may better understand the detailed description that follows. Additional features and advantages of the disclosure will be described hereinafter that form the subject of the claims. Those of ordinary skill in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of an energy monitoring environment in which various embodiments of the present disclosure are implemented;

FIG. 2 illustrates a block diagram of a data processing system in which various embodiments of the present disclosure are implemented;

FIG. 3 illustrates a block diagram of a building management system in which various embodiments of the present disclosure are implemented;

FIG. 4 depicts a flowchart of a process for generating an adjusted energy usage baseline in accordance with disclosed embodiments; and

FIGS. 5A and 5B illustrate graphs of energy usage baselines generated in accordance with various embodiments of the present disclosure.

### DETAILED DESCRIPTION

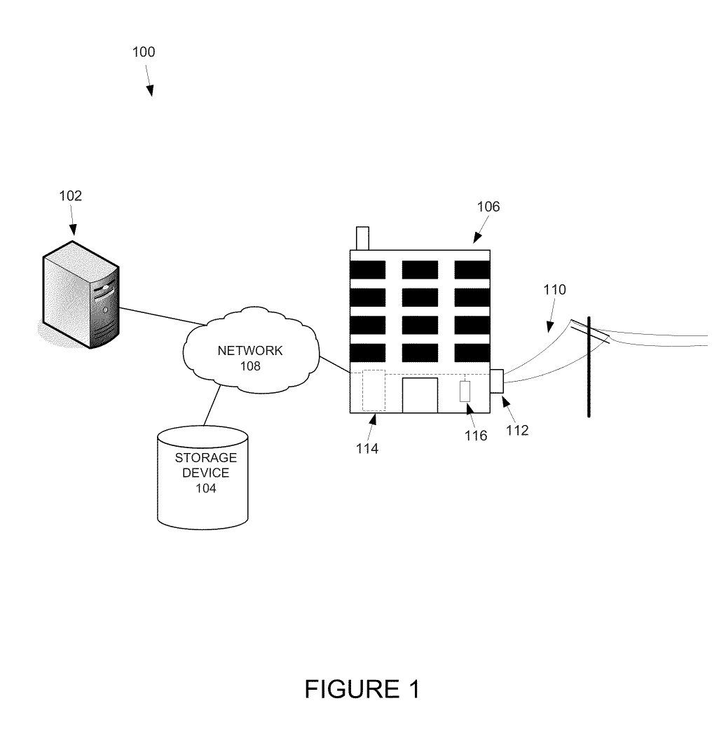

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

Disclosed embodiments reduce an amount of time needed to establish a baseline of energy usage in a building while improving accuracy of the energy usage baseline. An energy usage baseline is a mathematical relationship for energy usage at a particular location as a function of temperature. As energy usage may vary based on temperature, an energy usage baseline is an effective way to represent energy consumption in a way that is adjusted for temperature.

Disclosed embodiments reduce the data gathering time by combining historical energy usage data with a sample of current energy usage measurements from the location to provide an accurate energy usage baseline extended over a temperature range. Disclosed embodiments utilize this energy usage baseline to measure the effect of energy efficiency measures, operational changes, and appliance changes.

FIG. 1 illustrates a block diagram of an energy monitoring environment 100 in which various embodiments are implemented. In this illustrative embodiment, the energy monitoring environment 100 includes a data processing system 102, connected to a storage device 104, and a building 106, via a network 108. The network 108 is a medium used to provide communication links between various data processing systems and other devices in the energy monitoring environment 100. Network 108 may include any number of suitable connections, such as wired, wireless, or fiber optic links. Network 108 may be implemented as a number of different types of networks, such as, for example, the internet, a local area network (LAN), or a wide area network (WAN).

Elements of the present disclosure may be implemented in the data processing system 102 and the storage device 104 in connection with the network 108. For example, the data processing system 102 may obtain both historical energy usage data and current energy usage measurements for the building 106 from the storage device 104 to generate an energy usage baseline. The building 106 is a location where energy usage is monitored. For example, an operator of the building 106 may desire to have current energy usage modeled for comparison with future energy usage.

The data processing system 102 may obtain historical energy usage data for the building 106 from historical utility data. For example, the data processing system 102 may obtain the historical energy usage data about energy usage at the building 106 for a prior period of time from information about utility bills or utility invoices stored in a database within the storage device 104.

The data processing system 102 also obtains historical temperature data for an area where the building 106 is located during the period of time for the historical utility data. For example, the data processing system 102 may obtain an average, high, and/or low temperature(s) for days, week, months, and/or years within the period of time covered by the historical energy usage data. The data processing system 102 may obtain this historical temperature data from one or more weather databases (e.g., a national weather service) that store information about temperature at different areas.

The data processing system 102 combines historical energy usage data with the historical temperature data to generate a historical energy usage baseline. This historical energy usage baseline represents energy usage at the building as a function of temperature for a previous period of time.

Disclosed embodiments recognize that data obtained for a previous period of time at the building 106 may not be accurate. For example, the historical energy usage data may not be accurate. Changes at the building 106 may affect energy consumption. For example, equipment maintenance, energy usage habits, seasonal variations, building traffic and use, building repair and maintenance issues may change the amount of energy consumed at the building 106. Disclosed embodiments modify this historical energy usage baseline to account for changes in energy usage.

To account for changes in energy usage, the data processing system 102 obtains energy usage measurements from the building 106 via the network 108 during a monitoring period. For example, the building 106 receives electrical energy from an energy source (e.g., power lines 110). Sensor 112 measures an amount of energy received at the building 106. A data processing system 114 at the building 106 receives the energy usage measurements from the sensor 112 and sends the energy usage measurements to data processing system 102 via the network 108.

The data processing system 102 also obtains temperature data for the area where the building 106 is located for the monitoring period. For example, the data processing system 102 may obtain an average, high, and/or low temperature(s) for days, week, and/or months that the energy usage measurements were obtained. The data processing system 102 may obtain this temperature data from one or more weather databases (e.g., a national weather service) that store information about temperature at different areas or from a temperature sensor 116 located at the building 106.

The data processing system 102 combines the energy usage measurements and the temperature data to generate a current energy usage baseline as a function of temperature. This current energy usage baseline spans a temperature range experienced during the monitoring period. The data processing system 102 generates a correction factor for the historical energy usage baseline based on differences with the current energy usage baseline for the temperature range experienced during the monitoring period. The data processing system 102 applies this correction factor for the entire range of temperatures of the historical energy usage baseline to generate an adjusted energy usage baseline. Because the energy usage measured during the monitoring period is applied to adjust the historical energy usage baseline, the actual amount of time needed to monitor energy usage at the building 106 is significantly reduced. For example, energy usage measurements for a months, weeks, or even days may be applied to historical data covering a year or more to adjust or correct the historical data for current operating conditions at the building 106. This correction produces accurate results for an energy usage baseline while reducing the actual amount of time needed to monitor energy usage at the building 106.

The description of energy monitoring environment 100 in FIG. 1 is indented as an example and not as a limitation on the various embodiments of the present disclosure. For example, the energy monitoring environment 100 may include additional server computers, client devices, and other devices not shown. In some embodiments, all or some of the functionality of the data processing system 102 may be implemented at the building 106 by the data processing system 102. In some embodiments, all or some of the functionality of the data processing system 102 may implemented in one or more server computers in a cloud computing environment within network 108.

In other embodiments, energy monitoring may occur for any different type of energy consumption unit. For example, various embodiments may be applied to any type of building or home, as well as, subsystems within the building or home. For example, without limitation, energy usage baselines may be generated for lighting systems, HVAC systems, or/and other type of building subsystem, as well as, individual components within the subsystems. Additionally, in some embodiments, the baselines may be generated for other types of energy or utilities. For example, the data processing system 102 may generate and adjust baselines for water consumption, natural gas, gasoline, and/or any other type of utility or energy resource.

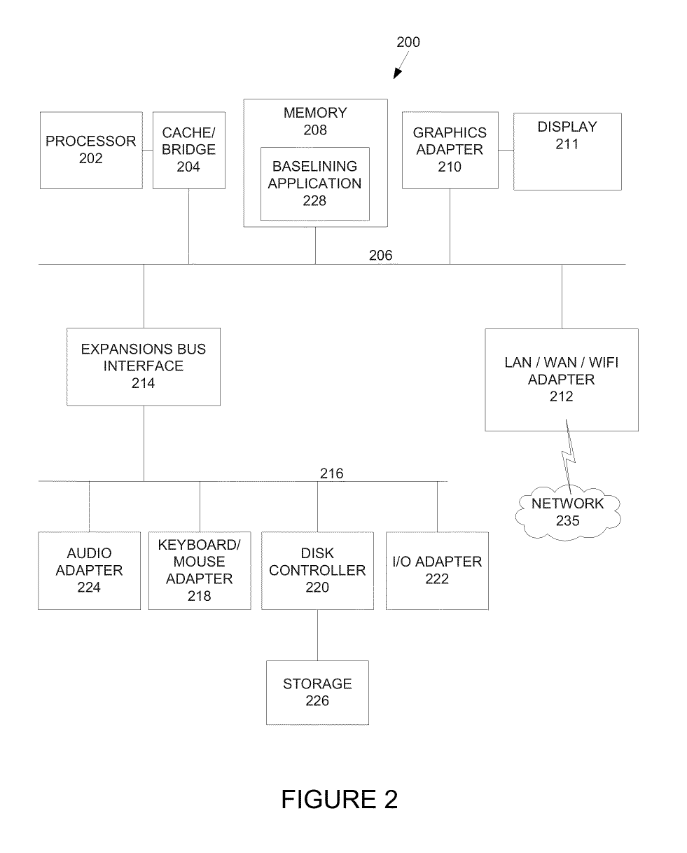

FIG. 2 depicts a block diagram of a data processing system 200 in which various embodiments are implemented. The data processing system 200 includes a processor 202 connected to a level two cache/bridge 204, which is connected in turn to a local system bus 206. The local system bus 206 may be, for example, a peripheral component interconnect (PCI) architecture bus. Also connected to local system bus in the depicted example are a main memory 208 and a graphics adapter 210. The graphics adapter 210 may be connected to a display 211.

Other peripherals, such as a local area network (LAN)/Wide Area Network/Wireless (e.g. WiFi) adapter 212, may also be connected to local system bus 206. An expansion bus interface 214 connects the local system bus 206 to an input/output (I/O) bus 216. The I/O bus 216 is connected to a keyboard/mouse adapter 218, a disk controller 220, and an I/O adapter 222. The disk controller 220 may be connected to a storage 226, which may be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to the I/O bus 216 in the example shown is an audio adapter 224, to which speakers (not shown) may be connected for playing sounds. The keyboard/mouse adapter 218 provides a connection for a pointing device (not shown), such as a mouse, trackball, trackpointer, etc. In some embodiments, the data processing system 200 may be implemented as a touch screen device, such as, for example, a tablet computer or touch screen panel. In these embodiments, elements of the keyboard/mouse adapter 218 may be implemented in the user interface 230 in connection with the display 211.

In various embodiments of the present disclosure, the data processing system 200 is a computer in the energy monitoring environment 100, such as the data processing system 102 or the data processing system 114. The data processing system 200 implements a baselining application 228. The baselining application 228 is a software application that generates a baseline for energy usage at a building. For example, baselining application 228 includes program code for generating a historical energy usage baseline, identifying a correction factor for the historical energy usage baseline from measured energy usage data, and generating an adjusted energy usage baseline.

The data processing system 200 obtains data for energy usage and temperature for a building. For example, twelve months of utility bills having a monthly energy usage and average daily temperature for the months corresponding to the utility bills. The data processing system 200 may obtain the data for energy usage and temperature from various databases. For example, the energy usage data may be obtained from a server of a utility service provider and the temperature data may be obtained from a server of a national weather service. In another example, the data processing system 200 may receive the energy usage and temperature data from another system or process or from a user entry. The data processing system 200 plots this data as a plurality of data points for energy and temperature. The data processing system 200 performs a regression analysis on the data points to generate a function of the mathematical relationship between temperature and energy usage. For example, this regression analysis may be a linear regression or a polynomial regression. This mathematical relationship between temperature and energy usage is the historical energy usage baseline.

The data processing system 200 also receives measurements of current energy usage for the building. For example, the data processing system 200 may receive energy usage measurements from an energy sensor (e.g., an electricity meter) located at the building. These energy usage measurements may be for different periods of time including one or more months, weeks, days, hours and/or minutes. The data processing system 200 receives values for temperature in the area where the building is located for the measurements of current energy usage. For example, the values for temperature may be an average temperature during the period of time that a measurement of energy usage was taken. The data processing system 200 may obtain the values for temperature from a server of a national weather service or a temperature sensor at the building. In some embodiments, the temperature values for the current energy usage are obtained from a same source as the temperature values for the historical energy usage baseline. In this example, the use of a same temperature data source may improve consistency between the historical data and the current data. The current energy usage measurements and temperature values are associated as energy usage and temperature data point pairs.

As the energy usage and temperature data is received, the data processing system 200 performs a regression analysis on the energy usage and temperature data point pairs to generate a function for the current relationship between temperature and energy usage for the building as a current energy usage baseline. With each data point pair received, the modeling of the current energy usage baseline for the building becomes more accurate. Given that the historical energy usage baseline involves measurements from a larger period of time (e.g., a year) than the current energy usage baseline (e.g., a few days or weeks), it is likely that the entire temperature range for the building may not be covered in the current energy usage baseline. In other words, the temperature range for the current energy usage baseline may only cover a portion of the temperature range of the historical energy usage baseline.

The data processing system 200 calculates a difference between the current energy usage baseline and the historical energy usage baseline to identify a correction factor to apply to the historical energy usage baseline to generate an adjusted energy usage baseline for the entire temperature range. In one illustrative example, the data processing system 200 performs an operation to integrate the function for the historical energy usage baseline and the function for the current energy usage baseline over the portion of the temperature range covered by the current energy usage baseline. In other words, the data processing system 200 calculates the area under the curve for both the historical energy usage baseline and the current energy usage baseline for the portion of the temperature range. The data processing system 200 subtracts the integral of the function for the current energy usage baseline from the integral of the function for historical energy usage baseline to obtain a difference. The data processing system 200 utilizes this difference to form a correction factor as a multiplier and/or offset for the historical energy usage baseline. For example, the correction factor may be a multiplier, offset, and/or function used to scale, shift, or otherwise adjust the historical energy usage baseline.

The data processing system 200 applies this correction factor to the historical energy usage baseline to generate an adjusted energy usage baseline. This adjusted energy usage baseline accounts for changes and inaccuracies in the historical energy usage baseline. By only needing to obtain measurements that cover a portion of the temperature range in the historical energy usage baseline, disclosed embodiments provide time cost savings in modeling energy usage. Additionally, disclosed embodiments apply detected changes detected in the energy usage patterns to the entire baseline producing an accurate model of the energy usage.

In order to accurately model the energy usage, disclosed embodiments use measurements that span a threshold temperature range of the historical energy usage baseline. For example, the data processing system 200 may continue to receive and use energy usage measurements until the threshold temperature range is reached. While more energy usage measurements and a greater temperature range may produce more accurate results, disclosed embodiments recognize that the overlap between temperature ranges may be based on the difference between the current energy usage baseline and the historical energy usage baseline. For example, the larger the correction factor for the historical energy usage baseline, the more overlap between temperatures is helpful to achieve sufficient accuracy. When the correction factor is smaller, the amount of overlap between temperatures of the current and historical data may be less to achieve similar levels of accuracy in the adjusted energy usage baseline.

Upon generation of the adjusted energy usage baseline, the data processing system 200 may utilize the adjusted energy usage baseline to generate estimates of future energy savings. For example, the data processing system 200 may compare estimated energy usage using energy saving products and systems to the adjusted energy usage baseline to produce accurate results for future energy savings.

Those of ordinary skill in the art will appreciate that the hardware depicted in FIG. 2 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

One of various commercial operating systems, such as a version of Microsoft Windows™, a product of Microsoft Corporation located in Redmond, Wash. may be employed if suitably modified. The operating system is modified or created in accordance with the present disclosure as described, for example, to implement the baselining application 228.

LAN/WAN/Wireless adapter 212 may be connected to a network 235, such as for example, MLN 120, (not a part of data processing system 200), which may be any public or private data processing system network or combination of networks, as known to those of skill in the art, including the Internet. Data processing system 200 may communicate over network 235 to one or more computers, which are also not part of data processing system 200, but may be implemented, for example, as a separate data processing system 200.

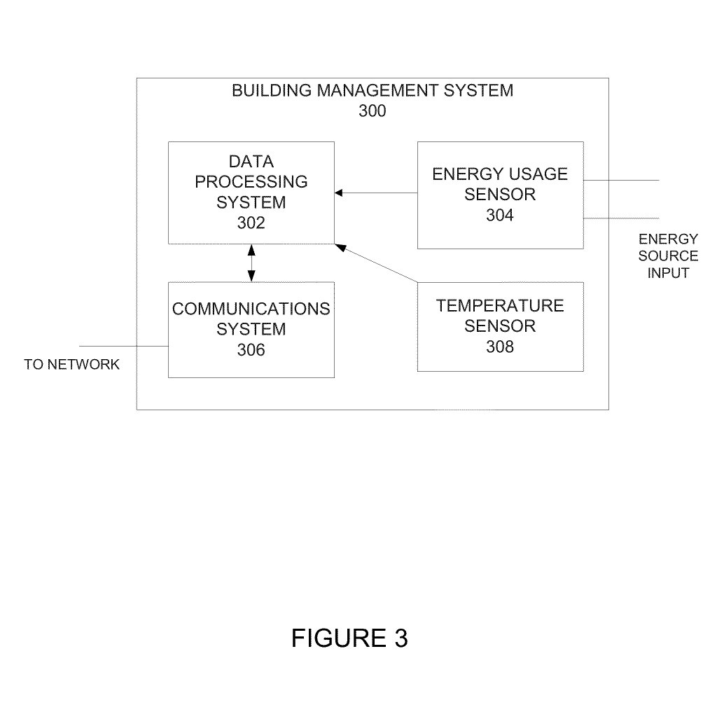

FIG. 3 illustrates a block diagram of a building management system 300 in which various embodiments are implemented. In these illustrative examples, the building management system 300 implements one or more functions within a building, such as the building 106 in FIG. 1. For example, building management system 300 may be an example of one embodiment of the sensor 112, the data processing system 114, temperature sensor 116, and/or the data processing system 200. For example, the building management system 300 may include building automation functions, energy usage monitoring functions, and temperature monitoring functions within the building.

The building management system 300 includes a data processing system 302 operably connected to an energy usage sensor 304, a communications system 306, and a temperature sensor 308. The energy usage sensor 304 obtains measurements of energy received from an energy source as energy usage for the building. The energy usage sensor 304 may be an electrical meter, smart meter, and/or any other type of energy usage sensor. The energy usage sensor 304 sends the measurements of energy usage to the data processing system 302. Data processing system 302 includes time stamping information with the measurements of energy received. This time stamping information may be used to associate the energy usage measurements with temperature values.

The data processing system 302 may also receive temperature values from the temperature sensor 308. The temperature sensor 308 may be a thermometer associated with the building that measures outdoor temperature at the building. Data processing system 302 includes time stamping information with the temperature values received. This time stamping information may be used to associate the temperature values with energy usage measurements.

In some embodiments, the data processing system 302 implements the baselining application 228. For example, the data processing system 302 may perform the functions for generating a historical energy usage baseline, identifying a correction factor for the historical energy usage baseline from measured energy usage data, and generating an adjusted energy usage baseline. For example, the data processing system 302 may receive the historical data via the communications system 306 from a network connected storage device and generate the correction factor and adjusted energy usage baseline based on measurements received from the energy usage sensor 304 and the temperature sensor 308. In another example, the data processing system 302 may receive the temperature values from an external source, for example, a same source that the temperature values for the historical data were received.

In other embodiments, the data processing system 302 sends, via the communications system 306, the measurements of energy usage with the time stamping information and the temperature values with the time stamping information for processing at by an external device, for example, the data processing system 102 in FIG. 1. In some embodiments, the temperature sensor 308 may not be included within building management system 300. Thus, the data processing system 302 may only send the measurements of energy usage.

In various embodiments, the energy usage sensor 304 measures energy usage by one or more subsystems and/or components within the building management system 300. For example, without limitation, the energy usage sensor 304 may measure energy usage by lighting systems, HVAC systems, and/or other type of subsystem within building management system 300, as well as, individual components within the subsystems. The data processing system 302 may process or send these energy usage measurements to identify energy usage baselines or comparisons for the subsystems and/or components within the building management system 300.

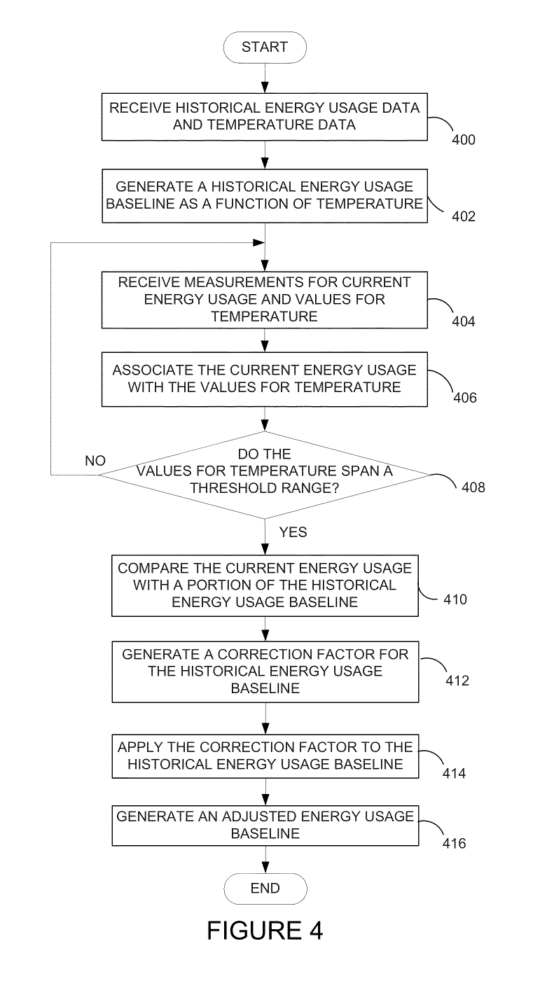

FIG. 4 depicts a flowchart of a process for generating an adjusted energy usage baseline in accordance with disclosed embodiments. This process may be performed, for example, in one or more data processing systems, such as, for example, the data processing system 200, configured to perform acts described below, referred to in the singular as “the system.” The process may be implemented by executable instructions stored in a non-transitory computer-readable medium that cause one or more data processing systems to perform such a process. For example, baselining application 228 may comprise the executable instructions to cause one or more data processing systems to perform such a process.

The process begins with the system receiving historical energy usage data and temperature data (step 400). In step 400, the historical energy usage data may be received from a server of a utility service provider and the historical temperature data may be received from a server of a national weather service. In another example, the data processing system 200 may receive the historical energy usage and temperature data from another system or process or from a user entry. The system generates a historical energy usage baseline as a function of temperature (step 402). In step 402, the data processing system 200 may generate the historical energy usage baseline from a regression analysis performed on data points for temperature and energy.

The system receives measurements for current energy usage and values for temperature (step 404). In step 404, the data processing system 200 may receive the measurements for current energy usage from the energy usage sensor 304 via the data processing system 302 and the communications system 306 in the building management system 300. In step 404, the data processing system 200 may receive the values for temperature from a same temperature source as the historical temperature data. In another example, the data processing system 200 may receive the energy usage and temperature data from another system or process or from a user entry.

The system associates the current energy usage with the values for temperature (step 406). In step 406, the data processing system 302 may compare time stamp information for the current energy usage data to periods of time for the values for temperature. The data processing system 302 may calculate an average temperature for a period of time for the current energy usage data.

The system determines whether the values for temperature span a threshold range of the historical energy usage baseline (step 408). In step 408, the data processing system 200 determines whether sufficient data has been received to accurately adjust the historical energy usage baseline. For example, the data processing system 200 may determine an amount of difference between the current energy usage data and historical usage data. The larger the amount of difference the larger the threshold range of the temperature overlap between the between the current energy usage data and historical usage data. If the values for temperature do not span the threshold range, the system returns to step 404 and continues to receive measurements for current energy usage and values for temperature.

When the values for temperature span the threshold range, the system compares the current energy usage with a portion of the historical energy usage baseline (step 410). In step 410, the portion of the historical energy usage baseline is the portion where the temperature ranges for the historical data and the current energy usage data overlaps. In comparing the current energy usage with a portion of the historical energy usage baseline, the data processing system 200 may identify a difference between the historical energy usage baseline and the current energy usage for the temperature range.

The system generates a correction factor for the historical energy usage baseline (step 412). In step 412, the data processing system 302 may generate the correction factor as a multiplier, offset, and/or function based on the difference between the historical energy usage baseline and the current energy usage for the temperature range.

The system applies the correction factor to the historical energy usage baseline (step 414). In step 414, for example, the data processing system 200 may multiply, scale, or otherwise adjust the historical energy usage baseline based on the correction factor. The system generates an adjusted energy usage baseline (step 416). In step 416, the data processing system 200 applies the correction factor to the entire temperature range of the historical energy usage baseline to generate the adjusted energy usage baseline. The adjusted energy usage baseline accounts for energy usage changes that may have occurred. The data processing system 200 may use this adjusted energy usage baseline to generate an estimated future energy savings for energy savings products and systems to be installed. This adjusted energy usage baseline may be stored and/or displayed to a user as a tangible output, for example, by data processing system 200. Thereafter, the process ends.

Of course, those of skill in the art will recognize that, unless specifically indicated or required by the sequence of operations, certain steps in the processes described above may be omitted, performed concurrently or sequentially, or performed in a different order.

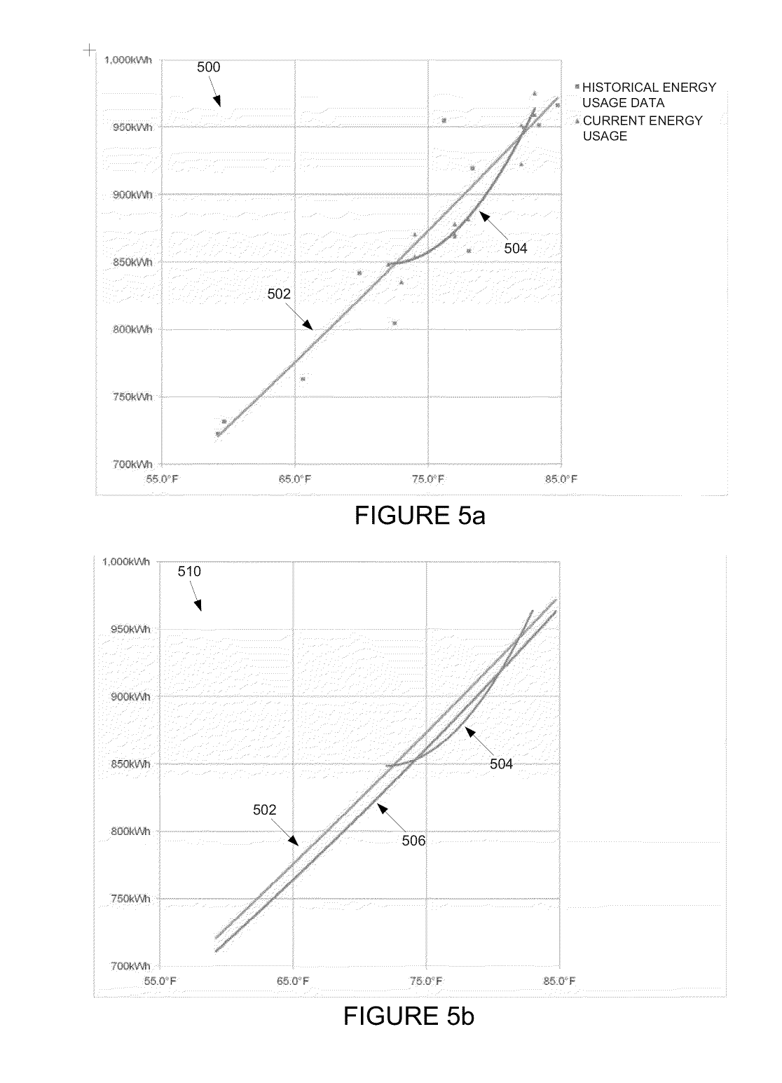

FIGS. 5A and 5B illustrate graphs of energy usage baselines generated in accordance with various embodiments of the present disclosure. Graph 500 in FIG. 5A illustrates the historical energy usage baseline 502 as a function of temperature generated from data points for historical energy usage data. In graph 500, the square shaped points represent data point pairs for historical energy usage and temperature data point pairs plotted on graph 500. For example, the data processing system 200 may identify a value for energy usage and a value for average temperature for a month and plot the data point pairs on graph 500. The data processing system 200 may perform a regression analysis on the data point pairs to generate the function for the historical energy usage baseline 502 plotted on graph 500. In this illustrative example, the function for historical energy usage baseline 502 is energy usage=0.0189*t²+7.1075*t+233.56 where t is the value for temperature.

Also included in graph 500 is a current energy usage baseline 504. In graph 500, the triangle shaped points represent data point pairs for energy usage measurements and temperature data point pairs plotted on graph 500. For example, the data processing system 200 may identify a value for a current energy usage measurement and a value for average temperature during the period of time the energy usage was measured and plot the data point pairs on graph 500. As depicted, the data point pairs for the current energy usage baseline 504 only span a portion of the temperature range of the historical energy usage baseline 502. For example, the temperature range of the historical energy usage baseline 502 is from about 59 degrees to about 84 degrees, while the temperature range of the current energy usage baseline 504 is from about 72 degrees to about 82 degrees. The data processing system 200 may perform a regression analysis on the data point pairs to generate the function for the current energy usage baseline 504 plotted on graph 500. In this illustrative example, the function for the current energy usage baseline 504 is energy usage=0.9417*t²+135.5*t+5722.8 where t is the value for temperature.

Graph 510 in FIG. 5B illustrates an adjusted energy usage baseline 506 generated based on historical energy usage baseline 502 and current energy usage baseline 504. For example, the data processing system 200 may calculate a difference between historical energy usage baseline 502 and current energy usage baseline 504 for the temperature range spanned by current energy usage baseline 504. In this example, the difference is averaged over the temperature range spanned by current energy usage baseline 504 to identify a correction factor. The data processing system 200 scales the historical energy usage baseline 502 by the correction factor to generate the adjusted energy usage baseline 506. In this illustrative example, the function for the adjusted energy usage baseline 506 is energy usage=0.0372*t²+4.5172*t+313.57 where t is the value for temperature. This adjusted energy usage baseline 506 may then be used to generate estimates of future energy usage savings. The graphs 500 and 510 may be stored and/or displayed to a user as a tangible output, for example by the data processing system 200.

Disclosed embodiments reduce an amount of time needed to establish adjusted baseline of energy usage in a building while improving accuracy of the historical energy usage baseline. Disclosed embodiments reduce the data gathering time by combining historical energy usage data with a sample of current energy usage measurements from the location to provide an accurate energy usage baseline extended over a temperature range. Disclosed embodiments utilize this adjusted energy usage baseline may be used to predict energy usage at a given temperature, more accurate than the historical baseline would provide, without requiring the long-term measurement period.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 200 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method in a data processing system for generating an energy usage baseline, the method comprising:
receiving historical energy usage data for a building;
identifying a historical energy usage baseline as a function of temperature based on the historical energy usage data;
receiving measurements for current energy usage for the building to form a set of energy usage measurements;
associating the set of energy usage measurements with values for temperature for an area where the building is located;
generating, using the data processing system, a correction factor for the historical energy usage baseline based on a comparison of the set of energy usage measurements with a portion of the historical energy usage baseline corresponding to the values for temperature associated with the set of energy usage measurements; and
generating an adjusted energy usage baseline by applying the correction factor to the historical energy usage baseline.

2. The method of claim 1, wherein identifying the historical energy usage baseline as a function of temperature comprises:
receiving temperature data for the area where the building is located for a period of time corresponding to the historical energy usage data from a database; and
identifying a range of temperatures for the period of time from the received temperature data, wherein the historical energy usage baseline comprises energy usage over the range of temperatures.

3. The method of claim 2 further comprising:
determining whether the values for temperature associated with the set of energy usage measurements span a threshold range of the range of temperatures for the historical energy usage baseline; and
responsive to determining that the values for temperature span the threshold range, generating the correction factor.

4. The method of claim 1, wherein associating the set of energy usage measurements with values for temperature for the area where the building is located comprises:
identifying a plurality of temperatures for the area where the building is located, one temperature for each day the current energy usage for the building is measured; and
associating each temperature in the plurality of temperatures with daily energy usage for a respective day the current energy usage for the building is measured to form a plurality of pairs of temperature and energy usage data points.

5. The method of claim 4, wherein generating the correction factor for the historical energy usage baseline comprises:
performing a regression analysis on the plurality of pairs of temperature and energy usage data points to form a current energy usage baseline as a function of temperature; and
generating the correction factor from a difference between the historical energy usage baseline and the current energy usage baseline.

6. The method of claim 1 further comprising:
receiving the measurements for the current energy usage from a sensor at the building until the values for temperature at the building associated with the set of energy usage measurements span a threshold range that is less than the range of temperatures for the historical energy usage baseline; and
generating the correction factor based on the measured energy usage for the building.

7. The method of claim 1 further comprising:
using the adjusted energy usage baseline to generate an estimated future energy usage,
wherein generating the correction factor for the historical energy usage baseline comprises:
identifying changes between historical and current energy usage habits at the building; and
adjusting the correction factor based on the identified changes.

8. A data processing system configured to generate an energy usage baseline, the data processing system comprising:
a storage device comprising a baselining application;
an accessible memory comprising instructions of the baselining application; and
a processor configured to execute the instructions of the baselining application to:
receive historical energy usage data for a building;
identify a historical energy usage baseline as a function of temperature based on the historical energy usage data;
receive measurements for current energy usage for the building to form a set of energy usage measurements;
associate the set of energy usage measurements with values for temperature for an area where the building is located;
generate a correction factor for the historical energy usage baseline based on a comparison of the set of energy usage measurements with a portion of the historical energy usage baseline corresponding to the values for temperature associated with the set of energy usage measurements; and
generate an adjusted energy usage baseline by applying the correction factor to the historical energy usage baseline.

9. The data processing system of claim 8, wherein to identify the historical energy usage baseline as a function of temperature, the processor is further configured to execute the instructions of the baselining application to:
receive temperature data for the area where the building is located for a period of time corresponding to the historical energy usage data from a database; and
identify a range of temperatures for the period of time from the received temperature data, wherein the historical energy usage baseline comprises energy usage over the range of temperatures.

10. The data processing system of claim 9, wherein the processor is further configured to execute the instructions of the baselining application to:
determine whether the values for temperature associated with the set of energy usage measurements span a threshold range of the range of temperatures for the historical energy usage baseline; and
generate the correction factor in response to determining that the values for temperature span the threshold range.

11. The data processing system of claim 8, wherein to associate the set of energy usage measurements with values for temperature for the area where the building is located, the processor is further configured to execute the instructions of the baselining application to:
identify a plurality of temperatures for the area where the building is located, one temperature for each day the current energy usage for the building is measured; and
associate each temperature in the plurality of temperatures with daily energy usage for a respective day the current energy usage for the building is measured to form a plurality of pairs of temperature and energy usage data points.

12. The data processing system of claim 11, wherein to generate the correction factor for the historical energy usage baseline, the processor is further configured to execute the instructions of the baselining application to:
perform a regression analysis on the plurality of pairs of temperature and energy usage data points to form a current energy usage baseline as a function of temperature; and
generate the correction factor from a difference between the historical energy usage baseline and the current energy usage baseline.

13. The data processing system of claim 8, wherein the processor is further configured to execute the instructions of the baselining application to:
receive the measurements for the current energy usage from a sensor at the building until the values for temperature at the building associated with the set of energy usage measurements span a threshold range that is less than the range of temperatures for the historical energy usage baseline; and
generate the correction factor based on the measured energy usage for the building.

14. The data processing system of claim 8, wherein the processor is further configured to execute the instructions of the baselining application to:
use the adjusted energy usage baseline to generate an estimated future energy usage,
wherein to generate the correction factor for the historical energy usage baseline the processor is further configured to execute the instructions of the baselining application to:
identify changes between historical and current energy usage habits at the building; and
adjust the correction factor based on the identified changes.

15. A non-transitory computer-readable medium encoded with executable instructions that, when executed, cause one or more data processing systems to:
receive historical energy usage data for a building;
identify a historical energy usage baseline as a function of temperature based on the historical energy usage data;
receive measurements for current energy usage for the building to form a set of energy usage measurements;
associate the set of energy usage measurements with values for temperature for an area where the building is located;
generate a correction factor for the historical energy usage baseline based on a comparison of the set of energy usage measurements with a portion of the historical energy usage baseline corresponding to the values for temperature associated with the set of energy usage measurements; and
generate an adjusted energy usage baseline by applying the correction factor to the historical energy usage baseline.

16. The computer-readable medium of claim 15, wherein the instructions that cause the one or more data processing systems to identify the historical energy usage baseline as a function of temperature comprise instructions that cause the one or more data processing systems to receive temperature data for the area where the building is located for a period of time corresponding to the historical energy usage data from a database and identify a range of temperatures for the period of time from the received temperature data, wherein the historical energy usage baseline comprises energy usage over the range of temperatures.

17. The computer-readable medium of claim 16, wherein the computer-readable medium is further encoded with executable instructions that, when executed, cause one or more data processing systems to:
determine whether the values for temperature associated with the set of energy usage measurements span a threshold range of the range of temperatures for the historical energy usage baseline; and
generate the correction factor in response to determining that the values for temperature span the threshold range.

18. The computer-readable medium of claim 15, wherein the instructions that cause the one or more data processing systems to associate the set of energy usage measurements with values for temperature for the area where the building is located comprise instructions that cause the one or more data processing systems to identify a plurality of temperatures for the area where the building is located, one temperature for each day the current energy usage for the building is measured and associate each temperature in the plurality of temperatures with daily energy usage for a respective day the current energy usage for the building is measured to form a plurality of pairs of temperature and energy usage data points.

19. The computer-readable medium of claim 18, wherein the instructions that cause the one or more data processing systems to generate the correction factor for the historical energy usage baseline comprise instructions that cause the one or more data processing systems to perform a regression analysis on the plurality of pairs of temperature and energy usage data points to form a current energy usage baseline as a function of temperature; and generate the correction factor from a difference between the historical energy usage baseline and the current energy usage baseline.

20. The computer-readable medium of claim 15, wherein the computer-readable medium is further encoded with executable instructions that, when executed, cause one or more data processing systems to:
receive the measurements for the current energy usage from a sensor at the building until the values for temperature at the building associated with the set of energy usage measurements span a threshold range that is less than the range of temperatures for the historical energy usage baseline; and
generate the correction factor based on the measured energy usage for the building.
